(19) United States
(12) Patent Application Publication
(10) Pub. No.: US 2019/0214869 A1
(43) Pub. Date: Jul. 11, 2019

(54) VEHICULAR HAIRPIN WINDING MOTOR AND MANUFACTURING METHOD THEREOF

(71) Applicants: Hyundai Motor Company, Seoul (KR); Kia Motors Corporation, Seoul (KR)

(72) Inventors: Sang Hoon Moon, Yongin (KR); Dong Yeon Han, Seoul (KR); Yeon Ho Kim, Suwon (KR); Woong Chan Chae, Gwangmyeong (KR); Young Jin Shin, Changwon (KR); Kyung Soo Park, Daejeon (KR); Hyoung Jun Cho, Suwon (KR); Jung Shik Kim, Seoul (KR)

(21) Appl. No.: 16/049,274

(22) Filed: Jul. 30, 2018

(30) Foreign Application Priority Data
Jan. 5, 2018 (KR) 10-2018-0001513

(51) Int. Cl. H02K 3/12; H02K 1/16; H02K 1/27; H02K 3/28; H02K 3/34; H02K 15/06; H02K 15/085; H02K 15/10

(52) U.S. Cl. CPC H02K 3/12; H02K 1/16; H02K 1/276; H02K 15/105; H02K 3/34; H02K 15/064; H02K 15/085; H02K 3/28

(57) ABSTRACT

A hairpin winding motor for a vehicle may include a hairpin including a pattern coil formed from a bundle of a plurality of coils; a stator including a slot in which the hairpin is arranged; and a rotor configured to move in response to the stator.

### CROSS-REFERENCE TO RELATED APPLICATION

This application claims under 35 U.S.C. § 119(a) the benefit of Korean Patent Application No. 10-2018-0001513, filed on Jan. 5, 2018, the entire contents of which are incorporated by reference herein.

### BACKGROUND

### (a) Technical Field

The present disclosure relates to a vehicular hairpin winding motor and a manufacturing method thereof, and more particularly, to the vehicular hairpin winding motor and a control method for improving energy efficiency in a vehicle including an electric motor and an inverter using electric energy.

### (b) Description of the Related Art

Electric vehicles use electric energy stored in batteries installed therein as a main energy source, as distinguished from gasoline/diesel vehicles using gasoline or diesel fuel. Accordingly, electric vehicles can include a high-voltage battery for storing electric energy, an electric motor corresponding to a power source, and an inverter for driving the electric motor. To increase range and energy efficiency of electric vehicles, battery capacity increases and methods for enhancing efficiencies of the inverter and the electric motor are proposed.

As a method for enhancing electric motor efficiency, a flat coil having a higher conductor-occupying ratio than an annular coil can be used. The ratio of the area of a coil in the same slot area is referred to as a conductor-occupying ratio. When the conductor-occupying ratio increases, wire wound resistance decreases, increasing electric motor efficiency. For example, when the flat coil is applied, the conductor-occupying ratio increases 10% or more compared to the conventional annular coil and thus efficiency improvement of the electric motor can be expected. However, the efficiency may be deteriorated due to AC resistance generated when AC flows through a conductive wire wound on a stator included in the electric motor or the inverter. Here, the AC resistance can be associated with skin effect and proximity effect. For example, when high-frequency current is applied to a coil, the current flows through the surface of the coil according to the skin effect. The skin effect is a phenomenon which occurs due to concentration of current on the surface of a conductor such as a coil according to reaction of induced electromotive force when AC is applied to the conductor. Accordingly, the skin effect and current distribution can be varied according to the frequency of AC, the area and shape of the conductor, etc. AC resistance can be calculated by applying high-frequency AC to a coil, measuring an AC voltage across both ends of the coil, converting the AC voltage into a root mean square (RMS) and applying Ohm's law.

When the annular coil is used for the electric motor or the inverter, AC resistance does not greatly affect efficiency because a roll of wires obtained by binding annular coils having a small coil area is used. However, when the flat coil is used for the electric motor or the inverter, a large coil area is required because it is difficult to use wires. Since the effect of AC resistance increases with respect to the flat coil used for a hairpin winding motor, for example, it is necessary to minimize the area of the flat coil in order to reduce AC resistance.

### SUMMARY

The present disclosure provides a device and method for improving a conductor-occupying ratio while restraining the skin effect and proximity effect by realizing a flat coil applicable to a hairpin winding motor.

In addition, the present disclosure provides a device and method for realizing a coil pattern corresponding to a flat coil by arranging a plurality of coils having a diameter of 1 mm or less in the horizontal and vertical directions and compressing the coils with an insulator to increase the conductor-occupying ratio while reducing AC resistance, thereby improving the power of a vehicular inverter or electric motor and energy efficiency.

Further, the present disclosure provides a device and method for realizing a coil pattern through a method of compressing and coating a plurality of coils using an insulator without an additional process and operation for insulating coils from each other to improve productivity such as time and cost in manufacture and assembly of the vehicular inverter or electric motor.

It will be appreciated by persons skilled in the art that the objects that could be achieved with the present disclosure are not limited to what has been particularly described hereinabove and the above and other objects that the present disclosure could achieve will be more clearly understood from the following detailed description.

A hairpin winding motor for a vehicle according to the present disclosure may include: a hairpin including a pattern coil formed from a bundle of a plurality of coils; a stator including a slot in which the hairpin is arranged; and a rotor configured to move in response to the stator. Preferably the stator includes a plurality of slots configured to receive corresponding hairpins.

Each of the plurality of coils may have a diameter of 1 mm or less, and the cross-sectional area of the pattern coil may correspond to the size of the slot.

The pattern coil may have a rectangular cross-sectional area in which n×m coils (n and m being natural numbers) are integrated.

The pattern coil may have a polygonal cross-sectional area.

The plurality of coils may be coated with an insulating material.

The plurality of coils may contact each other without being insulated with an insulator.

The pattern coil may include an insulator surrounding the plurality of coils.

The conductor-occupying ratio of the pattern coil may be 55 to 70%.

The external diameter of the rotor with respect to the external diameter of the stator may increase in response to the conductor-occupying ratio of the pattern coil.

The slot may have an area reduced in response to the conductor-occupying ratio of the pattern coil.

A method of manufacturing a hairpin winding motor for a vehicle according to the present disclosure may include: generating a pattern coil formed from a bundle of a plurality of coils corresponding to an area of a slot included in a stator; molding a hairpin using the pattern coil; and arranging the hairpin in the slot in the stator.

The generating of the pattern coil may include binding the plurality of coils and then coating the coils with an insulator.

Each of the plurality of coils may have a diameter of 1 mm or less and the cross-sectional area of the pattern coil may correspond to the size of the slot.

The pattern coil may have a rectangular cross-sectional area in which n×m coils (n and m being natural numbers) are integrated.

The pattern coil may have a polygonal cross-sectional area.

The above-described embodiments of the present disclosure are merely part of preferred forms of the present disclosure and various forms reflecting the technical features of the present disclosure can be derived and understood by those skilled in the art on the basis of the following detailed description of the present disclosure.

The device according to the present disclosure has the following effects.

The present disclosure can restrain AC resistance to a level similar to the conventional annular coil by decreasing an individual conductor area, compared to the conventional flat coil, using a coil pattern corresponding to a flat coil.

In addition, the present disclosure improves the conductor-occupying ratio by 10% or more, compared to the conventional annular coil, and thus driving motor main use region efficiency can be expected to increase by 1% or more.

Further, the present disclosure can facilitate automation of coil winding, compared to the conventional annular coil, to reduce manufacturing costs.

Moreover, the present disclosure can restrain coil temperature increase by decreasing resistance, compared to the conventional annular coil, to reduce copper loss, and easily cool a coil end to improve cooling performance of a motor.

It will be appreciated by persons skilled in the art that the effects that can be achieved with the present disclosure are not limited to what has been particularly described hereinabove and other advantages of the present disclosure will be more clearly understood from the following detailed description.

### BRIEF DESCRIPTION OF THE DRAWINGS

The accompanying drawings, which are included to provide a further understanding of the disclosure and are incorporated in and constitute a part of this application, illustrate form(s) of the disclosure and together with the description serve to explain the principle of the disclosure.

FIG. 1 is a cross-sectional view of a hairpin winding motor.

FIG. 2 is an isolated view of a hairpin for use in the hairpin winding motor of FIG. 1.

FIGS. 3A and 3B are views of a hairpin having the form of an annular coil and a flat coil, respectively.

FIG. 4 is a schematic view illustrating generation of loss due to AC resistance in a flat coil hairpin.

FIG. 5 is a schematic view of a hairpin structure capable of improving efficiency.

FIG. 6 is a graph illustrating an AC resistance reduction phenomenon in an example to which the hairpin structure of FIG. 5 is applied through comparison between an annular coil and a flat coil.

FIG. 7 is a flowchart of a method of manufacturing a hairpin winding motor.

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, a device and various methods to which forms of the present disclosure are applied will be described in more detail with reference to the attached drawings.

In the following description of forms, it will be understood that when an element is referred to as being “on” another element, it can be directly on the other element or intervening elements may be present therebetween. Further, the expression “on” or “under” may be used herein to represent the relationship of one element to another element as illustrated in the figures. It will be understood that this expression is intended to encompass different orientations of the elements in addition to the orientation depicted in the figures, namely, to encompass both “on” and “under”.

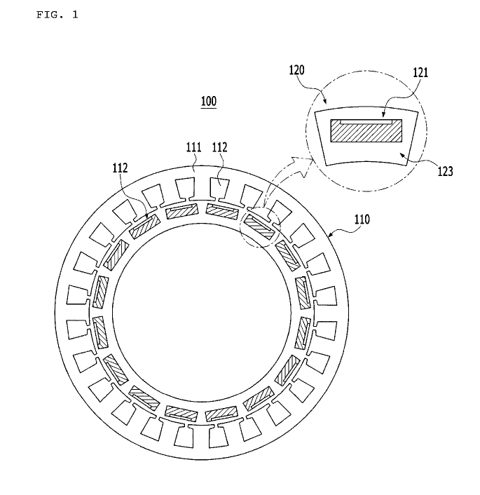

FIG. 1 is a cross-sectional view of a hairpin winding motor.

As shown, a hairpin winding motor 100 may include a stator 110 and a rotor 120 rotatably positioned inside of the stator 110. Here, the stator 110 may be formed in such a manner that multiple steel plates are laminated in a cylindrical form corresponding to the shape of the hairpin winding motor 100. The stator 110 may include a stator core 111 on which hairpins are wound and slots 112 arranged in the circumferential direction of the stator core 111. In addition, the rotor 120 may be formed in such a manner that multiple steel plates are laminated in a cylindrical form to correspond to the stator 110 and may be inserted into the hollow of the stator 110. The rotor 120 may include a rotor core 123 and a plurality of permanent magnets 121 arranged in the circumferential direction along the rotor core 123.

The permanent magnets 121 can be irreversibly demagnetized due to temperature change and/or the influence of magnetic flux from the rotating stator. That is, the magnetism of the permanent magnets 121 can be reduced to the point of irreversible demagnetization. Particularly, irreversible demagnetization may occur in the permanent magnets 121 due to generation of heat caused by copper loss that can occur when the hairpin winding motor 100 rotates at a high speed. However, copper loss may decrease according to the shape of the hairpin winding motor 100.

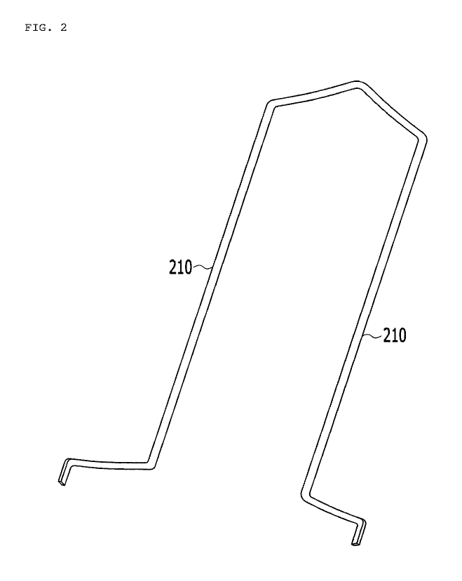

FIG. 2 is an isolated view of a hairpin for use in the hairpin winding motor of FIG. 1.

As shown, a hairpin 200 may be formed in a U shape or a V shape. Here, multiple hairpins 200 are bonded to form a coil winding part and may include a conductor.

The hairpin 200 may include a pair of legs 210 and a head 220. The pair of legs 210 is inserted into and combined with the slot (112 in FIG. 1) of the stator 110. In addition, each leg 210 is accommodated in the slot (112 in FIG. 1) of the stator 110 and part thereof is exposed to the outside of the slot 112 of the stator 110. Further, the end of each leg 210 may be coupled to a leg of another hairpin.

The conventional hairpin 200 is formed from a flat coil such as a rectangular coil having a rectangular cross section. Although the flat coil can increase the conductor-occupying ratio of the coil in the slot (112 of FIG. 1) to improve motor power, the efficiency thereof may be deteriorated due to skin effect and proximity effect. Here, the skin effect is a phenomenon which occurs due to concentration of current on the surface of a conductor according to reaction of induced electromotive force when AC is applied to the conductor. The skin effect and current distribution can be changed according to the frequency of AC, the area and shape of the conductor, and the like. The proximity effect refers to a phenomenon that current distributions in conductors in proximity to each other vary due to reciprocal action of magnetic fields formed by the conductors. The proximity effect and current distributions may be varied according to a distance between conductors in proximity to each other and current directions.

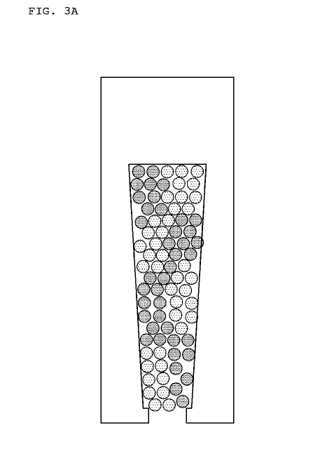

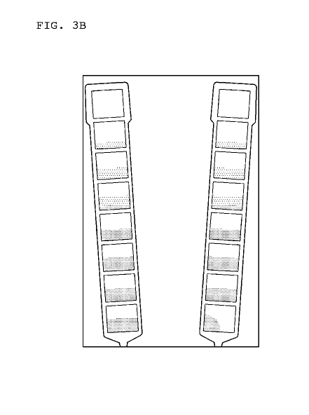

FIGS. 3A and 3B are views of a hairpin having the form of an annular coil and a rectangular coil, respectively. Specifically, FIG. 3A illustrates an annular coil configured of multiple coils having a diameter of 1 mm or less and FIG. 3B illustrates a flat coil having a rectangular cross section.

As shown, the annular coil of FIG. 3A can be manufactured through a method of winding a cylindrical copper wire having a small diameter into a slot. In this case, the conductor-occupying ratio may be approximately 40% (i.e., a dead space that is not occupied by the coil in the slot is approximately 60%). In the case of the annular coil, the percentage of the dead space in the slot area increases as the conductor-occupying ratio decreases, increasing the volume and weight of a motor at the same power, and causing power density to decrease at the same power.

On the other hand, when the rectangular coil or the flat coil is used as shown in FIG. 3B, a conductor-occupying ratio of approximately 55% can be obtained. When the flat coil is used, the dead space decreases and thus the slot area can be reduced, compared to the annular coil. Compared with a normal annular coil under the same power condition, the flat coil can cause the volume and weight of a motor to be reduced, increasing power density.

Referring to FIGS. 3A-3B, it can be easily understood that the conductor-occupying ratio of the flat coil of FIG. 3B is higher than that of the annular coil of FIG. 3A. For example, the coil conductor-occupying ratio (bare copper/slot area ratio) of the flat coil can increase by 10% or more compared to the annular coil. This is because the flat coil of FIG. 3B can be designed to correspond to the size of the slot although the slot of the annular coil of FIG. 3A is difficult to fill without an empty space.

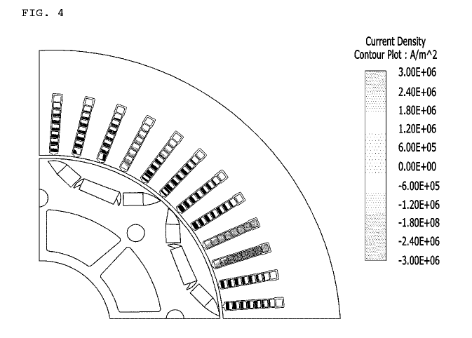

FIG. 4 illustrates generation of loss due to AC resistance in a flat coil hairpin. As shown, current density of hairpins included in a hairpin winding motor is distributed in various manners, which can be understood as generation of a current density difference due to loss caused by AC resistance.

For example, loss can be estimated through current density of the hairpin. Here, current density (J=I/S in unit of A/m²) is the quantity of current flowing through a unit area per unit time (e.g., 1 second) and can be obtained by dividing flowing current I by the cross-sectional area S. Microscopically, relation between a conductive wire and the cross-sectional area thereof can be observed. Particularly, considering a case in which the quantity of moving charges varies according to position, the influence of the size and direction of the area can be determined through current per unit area, that is, current density corresponding to a vector quantity.

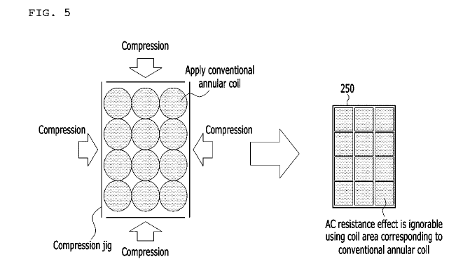

FIG. 5 illustrates a hairpin structure capable of improving efficiency. Specifically, the hairpin structure illustrated in FIG. 5 relates to the cross section of the hairpin 200 illustrated in FIG. 2.

As shown, the cross section of the hairpin 200 has a pattern in which multiple coils are arranged in a matrix form and compressed into one. For convenience of description, such a pattern having a structural difference from the conventional rectangular coil (flat coil) or annular coil is called a pattern coil 250.

The pattern coil 250 may be formed by arranging multiple coils used for the conventional annular coil in n×m (width×height) and then compressing the arranged coils in four or more directions using a jig. The cross section of the pattern coil 250 can correspond to the size of the slot 112 of the stator 110 included in the hairpin winding motor 100, like a flat coil. Here, it is possible to form the pattern coil 250 having a cross section similar to that of a single flat coil using multiple coils, instead of a single flat coil that can have a cross section corresponding to the size of the slot 112. For example, the cross section of the pattern coil 250 can be a rectangular or polygonal shape.

According to a form, the multiple coils included in the pattern coil 250 may be coils having a diameter of 1 mm or less used for the conventional annular coil. As the diameter or the cross section of each coil included in the pattern coil 250 decreases, the AC resistance effect of the pattern coil 250 can be enhanced. This is because the skin effect or the proximity effect can be reduced using a coil having a small cross section. Further, the skin effect or the proximity effect can be reduced without coating the coils included in the pattern coil 250 with an insulating material.

Moreover, as the diameter or the cross section of each coil included in the pattern coil 250 decreases, the pattern coil 250 can be formed in a polygonal shape having a cross section corresponding to the size of the slot 112 to increase the conductor-occupying ratio.

Insulation between coils in the same slot 112 can be easily achieved and convenience in assembly and processing processes can be enhanced by coating the surface of the pattern coil 250 including the multiple coils using an insulating material. In addition, the pattern coil coated with the insulating material can facilitate an operating process such as bending in a process of molding the hairpin 200, compared to the conventional flat coil that is not coated with an insulating material.

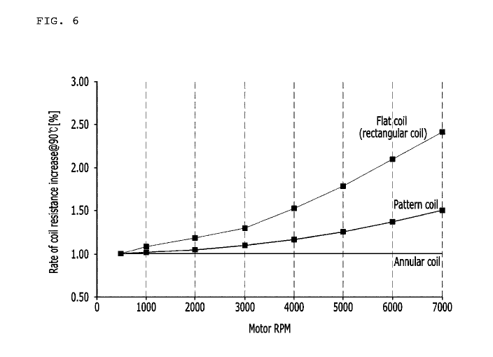

FIG. 6 is a graph illustrating an AC resistance reduction phenomenon in an example to which the hairpin structure illustrated in FIG. 5 is applied through comparison between an annular coil and a flat coil.

As shown, the result obtained by measuring and estimating the rate of AC resistance increase of a hairpin coil in response to the RPM of a hairpin winding motor can vary according to the cross-sectional structure of a hairpin. For example, AC resistance does not substantially increase in response to RPM increase in the case of the annular coil, whereas the rate of AC resistance increase increases in response to RPM increase in the case of the flat coil.

Meanwhile, in the case of a pattern coil formed by binding multiple coils, the rate of AC resistance increase gently increases in response to RPM increase, compared to the flat coil. Accordingly, the pattern coil can have a conductor-occupying ratio (e.g., 55 to 60% or 60 to 70% or higher) equal to or higher than that of the flat coil and thus can increase motor power, and can be designed such that the rate of AC resistance increase is similar to that of the annular coil rather than the flat coil.

The aforementioned conductor-occupying ratio increase (10% or more) of the pattern coil can increase the external diameter of the rotor compared to the external diameter of the stator included in the hairpin winding motor. When the external diameter of the rotor of the hairpin winding motor increases due to a conductor-occupying ratio increase of the coil, the same torque can be generated with less power. Further, the lamination length needs to be reduced in order to generate the same motor torque, and thus the volume and weight of the hairpin winding motor can decrease to enhance the power density of the hairpin winding motor (approximately 10% or more).

The aforementioned conductor-occupying ratio increase (10% or more) of the pattern coil can reduce the size of the slot included in the stator. In this case, the stator can be designed such that the stator teeth are short and wide and thus teeth saturation can be improved to enhance total harmonic distortion (THD) of counter electromotive force.

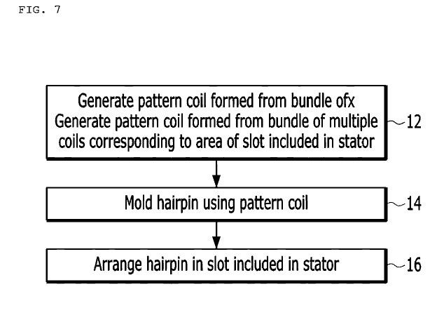

FIG. 7 is a flowchart of a method of manufacturing a hairpin winding motor.

As shown, the method of manufacturing a hairpin winding motor may include a step 12 of generating a pattern coil using a bundle of a plurality of coils corresponding to the area of a slot included in a stator, a step 14 of molding a hairpin using the pattern coil, and a step 16 of arranging the hairpin in the slot included in the stator.

In addition, the step 12 of generating the pattern coil may include a step of binding the plurality of coils and coating the coils with an insulator (not shown).

As in the above-described form, the pattern coil forming the hairpin included in the hairpin winding motor has a reduced individual conductor area compared to the conventional flat coil and thus may be designed to have AC resistance similar to that of the conventional annular coil. For example, the conductor occupying ratio can be improved by 10% or more compared to the conventional annular coil, and thus motor main use region efficiency can be increased by 1% or more.

In addition, the pattern coil forming the hairpin included in the hairpin winding motor facilitates automation of coil winding compared to the conventional annular coil, and thus manufacturing costs can be reduced.

Further, the pattern coil forming the hairpin included in the hairpin winding motor decreases resistance compared to the conventional annular coil to reduce copper loss. Accordingly, coil temperature increase can be suppressed and the coil end can be easily cooled to enhance cooling performance of the motor.

The aforementioned method according to the form may be implemented as a program executed in a computer and stored in a computer-readable recording medium. Examples of the computer-readable recording medium include a ROM, a RAM, a CD-ROM, a magnetic tape, a floppy disk, an optical data storage device, etc.

The computer-readable recording medium may be distributed to computer systems connected through a network, stored and executed as code readable in a distributed manner. Functional programs, code and code segments for implementing the aforementioned method may be easily deduced by programmers skilled in the art.

Those skilled in the art will appreciate that the present disclosure may be carried out in other specific ways than those set forth herein without departing from the spirit and essential characteristics of the present disclosure.

Accordingly, the above forms are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

What is claimed is:

1. A hairpin winding motor for a vehicle, the hairpin winding motor comprising:
a hairpin including a pattern coil formed from a bundle of a plurality of coils;
a stator including a slot in which the hairpin is arranged; and
a rotor configured to move in response to the stator.

2. The hairpin winding motor according to claim 1, wherein each of the plurality of coils has a diameter of 1 mm or less, and a cross-sectional area of the pattern coil corresponds to a size of the slot.

3. The hairpin winding motor according to claim 2, wherein the pattern coil has a rectangular cross-sectional area in which n×m coils (n and m being natural numbers) are integrated.

4. The hairpin winding motor according to claim 2, wherein the pattern coil has a polygonal cross-sectional area.

5. The hairpin winding motor according to claim 1, wherein the plurality of coils is coated with an insulating material.

6. The hairpin winding motor according to claim 1, wherein the plurality of coils contacts each other without being insulated with an insulator.

7. The hairpin winding motor according to claim 1, wherein the pattern coil includes an insulator surrounding the plurality of coils.

8. The hairpin winding motor according to claim 1, wherein a conductor-occupying ratio of the pattern coil is 55 to 70%.

9. The hairpin winding motor according to claim 8, wherein an external diameter of the rotor with respect to an external diameter of the stator increases in response to the conductor-occupying ratio of the pattern coil.

10. The hairpin winding motor according to claim 8, wherein the slot has an area reduced in response to the conductor-occupying ratio of the pattern coil.

11. A method of manufacturing a hairpin winding motor for a vehicle, the method comprising:
generating a pattern coil formed from a bundle of a plurality of coils corresponding to an area of a slot included in a stator;
molding a hairpin using the pattern coil; and
arranging the hairpin in the slot in the stator.

12. The method according to claim 11, wherein generating the pattern coil comprises binding the plurality of coils and coating the coils with an insulator.

13. The method according to claim 11, wherein each of the plurality of coils has a diameter of 1 mm or less, and the cross-sectional area of the pattern coil corresponds to the size of the slot.

14. The method according to claim 13, wherein the pattern coil has a rectangular cross-sectional area in which n×m coils (n and m being natural numbers) are integrated.

15. The method according to claim 13, wherein the pattern coil has a polygonal cross-sectional area.
